(19) United States
(12) Patent Application Publication
(10) Pub. No.: US 2005/0274571 A1
(43) Pub. Date: Dec. 15, 2005

(54) Convertible fiberglass ladder

(76) Inventors: Dennis Simpson, Minnetonka, MN (US); Wang Ching Ting, Hsin Chu (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/004,033

(22) Filed: Dec. 3, 2004

Related U.S. Application Data
(60) Provisional application No. 60/579,018, filed on Jun. 11, 2004.

(51) Int. Cl. E06C 1/00

(52) U.S. Cl. 182/23

(57) ABSTRACT

A convertible ladder having a first ladder section and a second ladder section. The first ladder section and the second ladder section each include a pair of side rails and at least one rung that extends between the side rails. The first ladder section further includes a pair of upper rail guides and a pair of intermediate rail guides. One of the upper rail guides is attached to each of the second side rails proximate an upper end thereof. One of the intermediate rail guides is attached to each of the second side rails intermediate the upper end and the lower end. The upper rail guides and the intermediate rail guides each include a recess that is adapted to at least partially receive one of the first side rails.

### REFERENCE TO RELATED APPLICATION

The present Application claims priority to U.S. Provisional Application No. 60/579,018, filed Jun. 11, 2204, entitled “Convertible Fiberglass Ladder.” The identified application is hereby incorporated by reference in its entirety.

### FIELD OF THE INVENTION

The invention relates generally to ladders. More particularly, the invention relates to convertible ladders made from fiberglass.

### BACKGROUND OF THE INVENTION

For some time it has been known that constructing ladders with two sections that are slidably mounted with respect to each other enables the overall length of the extension ladder to be varied depending upon the desired use of the extension ladder. This feature is particularly useful for transporting the ladder to a desired use location.

Conventional extension ladders do not have the ability to stand up without being leaned against another object. In certain circumstances it is not possible to lean the extension ladder against other objects. To overcome this limitation, Kummerlin et al., U.S. Pat. No. 3,692,143, pivotally attaches two extension ladders together. This ladder retained the benefits of being able to adjust the height of the ladder while adding the benefit that the ladder could remain erect without leaning against other objects.

Further, Moss et al., U.S. Patent Publication No. 2004/0140156A1, entitled “Combination Ladders, Ladder Components and Methods of Manufacturing Same” is directed to a combination ladder, where the inner rails of the ladder slide with respect to the outer rails of the ladder, thus extending the ladder. The outer rails of the ladder can be maintained in a stepladder configuration, while the inner rails are extended, to form an extended stepladder. A sliding mechanism is fixed to an outer rail and slidably coupled to an inner rail to facilitate sliding of an inner rail with respect to an outer rail. Ladder hinges are configured to transmit loads from associated rails, and in one embodiment, include a pinch prevention mechanism.

Boothe, U.S. Pat. Nos. 4,407,045 and 4,566,150, are both directed to a hinge for an articulating ladder. The hinge includes two hinge plates that are pivotally attached with a central hub. Pivoting of the hinge plates is controlled with a locking handle that extends through apertures in the hinge plates. The locking handle is biased to a locking position where the legs on the locking handle extend into the hinge plate apertures.

### SUMMARY OF THE INVENTION

The invention is directed to a convertible ladder having a first ladder section and a second ladder section. The first ladder section includes a pair of first side rails, at least one first rung, a pair of upper rail guides and a pair of intermediate rail guides. The pair of first side rails have an upper end and a lower end. The at least one first rung extends between the pair of first side rails.

One of the upper rail guides is attached to each of the first side rails proximate an upper end thereof. The upper rail guide includes an upper channel. One of the intermediate rail guides is attached to each of the first side rails intermediate the upper end and the lower end. The intermediate rail guide includes an intermediate channel.

The second ladder section includes a pair of second side rails and at least one second rung. The pair of second side rails have an upper end and a lower end. The upper channel and the intermediate channel are both adapted to at least partially receive one of the second side rails. The at least one second rung extends between the pair of second side rails.

### BRIEF DESCRIPTION OF THE DRAWINGS

FIG. 1 is a perspective view of a convertible ladder according to an embodiment of the invention in a first configuration.

FIG. 2 is a perspective view of the convertible ladder in a second configuration.

FIG. 3 is a partially exploded perspective view of a first ladder section.

FIG. 4 is an inner view of a first side rail of the first ladder section.

FIG. 5 is an exploded perspective view of an upper end of the first ladder section.

FIG. 6 is an exploded perspective view of an intermediate portion of the first ladder section.

FIG. 7 is a perspective view of the lower end of the first side rail.

FIG. 8 is a perspective view of a rail locking mechanism for the first ladder section.

FIG. 9 is a perspective view of the static hinge mechanism in an unassembled configuration.

FIG. 10 is a perspective view of the static hinge mechanism in an assembled configuration.

FIG. 11 is a perspective view of the first ladder sections attached together with the static hinge mechanism.

FIG. 12 is a perspective view of a rung attached to a second side rail on a second ladder section.

### DETAILED DESCRIPTION

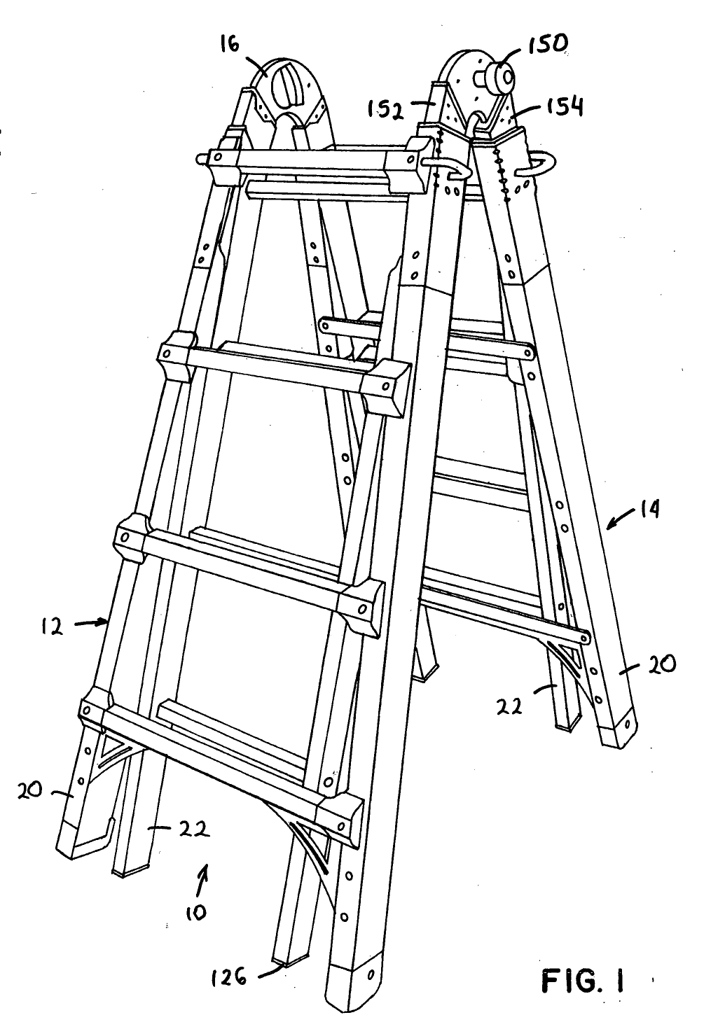

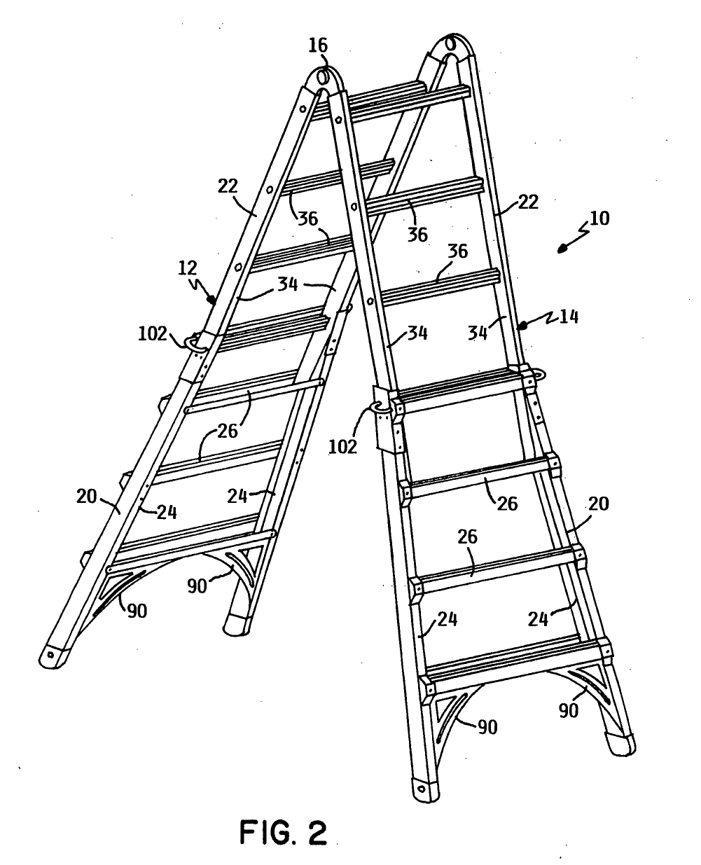

An embodiment of the invention is directed to a convertible fiberglass ladder, as most clearly illustrated at 10 in FIGS. 1-2. The convertible ladder 10 includes a first ladder portion 12 and a second ladder portion 14 that are interconnected with a hinge mechanism 16. The first ladder portion 12 and the second ladder portion 14 each preferably include a first ladder section 20 and a second ladder section 22. The first ladder section 20 and the second ladder section 22 in the first ladder portion 12 and the second ladder portion 14 are both slidably attached together.

The convertible ladder 10 is convertible between at least four different configurations. In a first configuration, the convertible ladder 10 is an extension ladder, where the first ladder portion 12 is substantially parallel to and aligned with the second ladder portion 14. In a second configuration, the convertible ladder 10 is an upright standing, 2-sided step ladder, wherein the first ladder portion 12 is oriented at an angle with respect to the second ladder portion 14.

In a third configuration, the first and second sections 20, 22 of the first ladder portion 12 and the second ladder portion 14 are separated from each other to form two separate ladders. In a fourth configuration, the convertible ladder 10 is adjusted so that the first ladder portion 12 and the second ladder portion 14 have different lengths to facilitate using the convertible ladder on uneven surfaces such as stairs.

As a result of the various configurations in which the convertible ladder 10 may be positioned, the convertible ladder 10 of the present invention takes the place of several different prior art ladders. The convertible ladder 10 thereby reduces the number of ladders that a person must own to do a variety of tasks.

The first section 20 includes a pair of first side rails 24 and a plurality of first rungs 26 that are mounted to extend between the first side rails 24 at selected intervals. The second ladder section 22 includes a pair of second side rails 34 and a plurality of second rungs 36 that are mounted to extend between the second side rails 34 at selected intervals.

The first side rails 24 and the second side rails 34 are both preferably fabricated from a non-metal material such as fiberglass. The first side rails 24 and the second side rails 34 both preferably have a substantially linear configuration. A person of ordinary skill in the art will appreciate that the size of the first side rails 24, the second side rails 34, the first rungs 26 and the second rungs 36 is selected based upon the intended use of the convertible ladder 10.

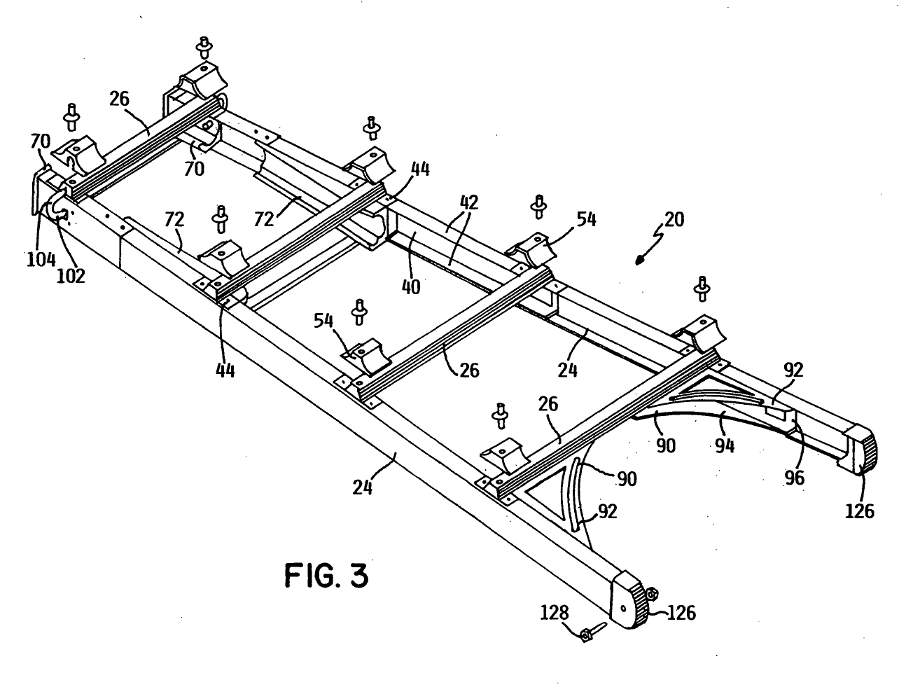

As most clearly illustrated in FIG. 3, the first side rails 24 preferably have a C-shaped configuration that permits the second side rails 34 to at least partially seat within the first side rails 24. Each of the first side rails 24 preferably includes a first rail web 40 and a pair of first rail legs 42 that both extend from the first rail web 40.

To enhance the structural rigidity of the first ladder section 20, the first rungs 26 preferably include an exterior reinforcement plate 44 proximate each end thereof. The exterior reinforcement plates 44 are generally oriented transverse to the first rung 26 to thereby enable each end of the first rung 26 to be attached at a lower point and an upper point.

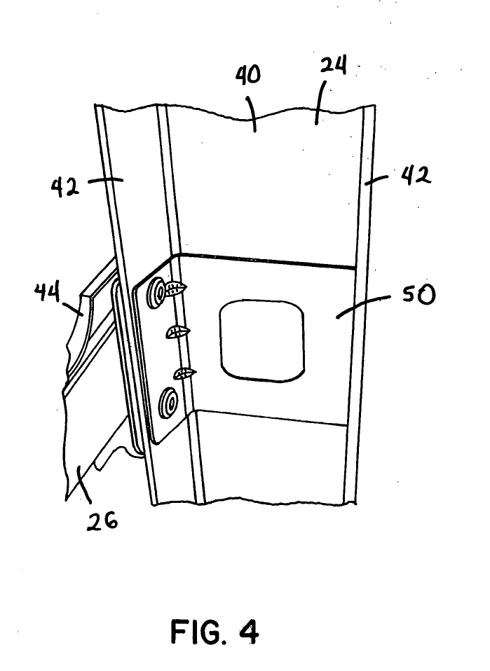

An interior reinforcement plate 50 can be positioned in the first rail web 40, proximate the location of a first rung 26, as illustrated in FIG. 4. The sides of the interior reinforcement plate 50 extend along the interior of the first rail legs 42. The interior reinforcement plate 50 is affixed to at least one of the first rail web 40 and the first rail legs 42 by a fastener. The interior reinforcement plate 50 may also be attached to the exterior reinforcement plate 52 by a fastener. A person of ordinary skill in the art will appreciate that the fastener can have a variety of configurations such as rivets, screws, bolts and the like.

In one embodiment, the first rungs 26 can have a cap 54 enclosing each end of the first rungs 26 as well as the exterior reinforcement plate 44, as illustrated in FIGS. 1 and 3. The cap 54 may be affixed to the end of a first rung 26 by a fastener, such as a bolt, screw and the like.

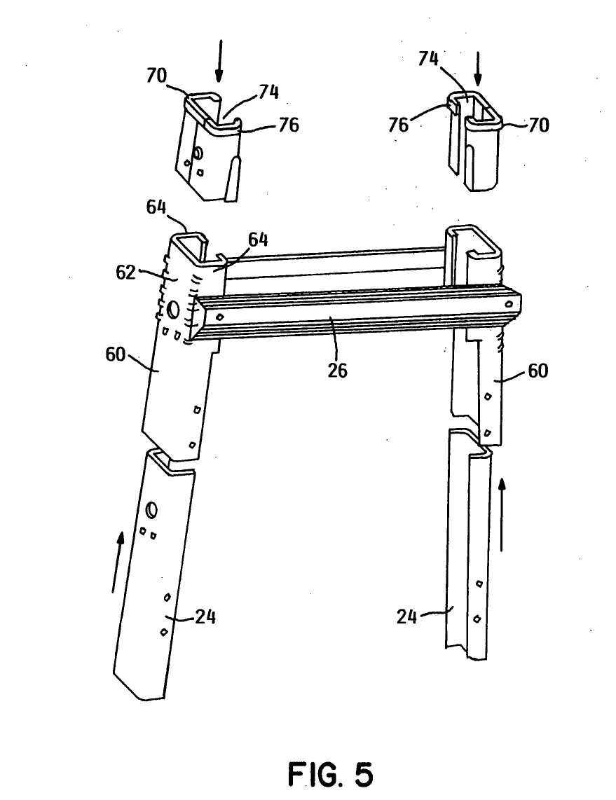

Proximate an upper end of the first side rails 24, an upper rail reinforcement 60 is preferably attached to each of the first side rails 24, as most clearly illustrated in FIGS. 3 and 5. The upper rail reinforcement 60 includes a reinforcement web 62 and a pair of reinforcement legs 64 that both extend from the reinforcement web 62 in a C-shaped configuration.

The upper rail reinforcement 60 not only enhances the strength and stability of the first side rails 24 and hence, the ladder, but also reduces the potential of damage to the first side rails 24. While illustrated as being on the outer surface of the first side rails 24, the upper rail reinforcement 60 may be positioned along the inner surface of the first side rails 24.

The uppermost first rung 26 is preferably permanently attached at each end to the upper rail reinforcement 60 such as by welding. This configuration not only enhances the structural rigidity of the first ladder section 20 but also reduces the time associated with assembling the first ladder section 20.

As most clearly illustrated in FIG. 1, the first side rails 24 are angled apart from each other so that a distance between the first side rails 24 proximate the lower end is greater than or equal to a distance between the first side rails 24 proximate the upper end. Using this configuration enhances the lateral stability of the convertible ladder 10.

Because the first side rails 24 are oriented at an angle with respect to each other and the second side rails 34 are oriented substantially parallel to each other, the lower ends of the first side rails 24 and the second side rails 34 on each side are spaced apart from each other while the upper ends of the first side rails 24 and the second side rails 34 on each side are located in proximity to each other, as most clearly illustrated in FIG. 1.

The first ladder section 20 preferably includes upper rail guides 70 and intermediate rail guides 72, as illustrated in FIG. 3. The upper rail guides 70 and the intermediate rail guides 72 are each adapted to engage the second ladder section 22 to guide the second ladder section 22 as the second ladder section 22 slides with respect to the first ladder section 20.

One of the upper rail guides 70 is attached to each of the first side rails 24 proximate an upper end thereof, as illustrated in FIGS. 3 and 5. One of the intermediate rail guides 72 is attached to each of the first side rails 24 at an intermediate location thereon.

The upper rail guide 70 has a channel 74 formed therein. The channel 74 has a length and a width that are approximately the same as the length and the width of the second side rails 34. The channel 74 preferably extends along at least three sides of the second side rail 34 and most preferably at least partially extends along the fourth side of the second side rail 34.

The channel 74 is oriented at an angle with respect to the first side rail 24 so that the channels 74 on opposite first side rails 24 are substantially parallel to each other. The upper rail guide 70 is preferably fabricated in two sections to facilitate attachment of the upper rail guide 70 to the first side rails 24.

The upper rail guide 70 preferably has a lip 76 that extends over the upper end of the first side rail 24 as well as the upper end of the upper rail reinforcement 60. The upper rail guides 70 not only prevent damage to the first side rails 24 and the upper rail reinforcement 60 but also reduce the potential of injury caused by contacting the potentially sharp ends of the first side rail 24 and the upper rail reinforcement 60.

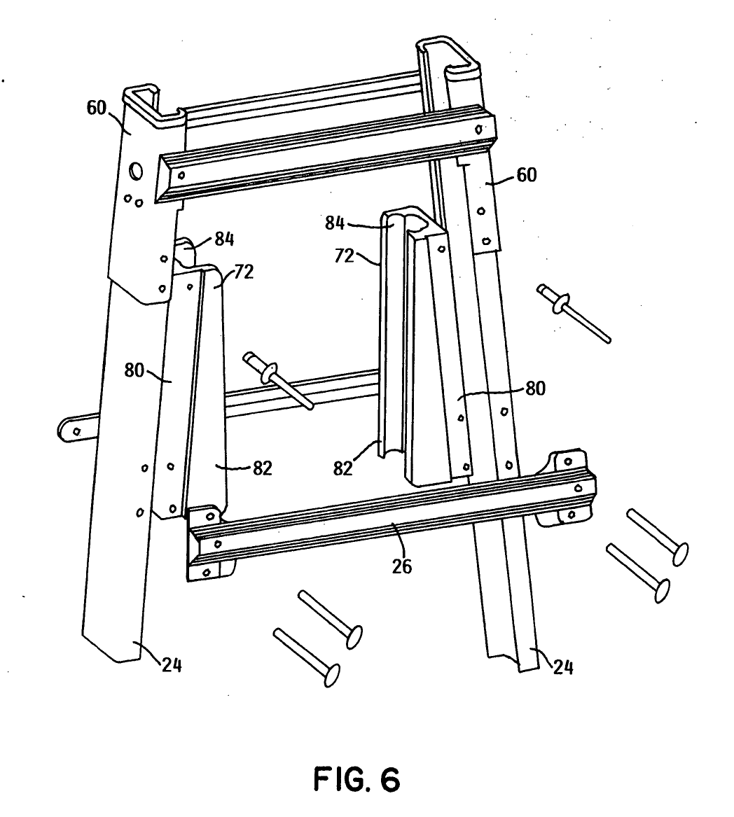

The intermediate rail guide 72 generally includes an attachment region 80 and a guide region 82, as illustrated in FIG. 6. The attachment region 80 preferably conforms to at least a portion of an inner surface on the first rail web 40 and the pair of first rail legs 42. This configuration thereby facilitates attachment of the intermediate rail guide 72 to the first side rail 24.

The guide region 82 has a channel 84 formed therein. The channel 84 has a length and a width that are approximately the same as the length and the width of the second side rails 34. The channel 84 preferably extends along at least three sides of the second side rail 34.

The channel 84 is preferably slightly larger than the second side rail 34 so that the second side rail 34 is slidable with respect to the intermediate rail guide 72 but resists lateral movement of the second side rail 34 with respect to the intermediate rail guide 72.

The guide region 82 is preferably oriented at an angle with respect to the attachment region 80 while being substantially parallel to the second side rail 34. The rail guide 72 thereby enhances sliding of the second section 22 with respect to the first section 20.

The first section 20 further preferably includes at least one brace 90 that interconnects the first side rails 24 and the first rung 26, as illustrated in FIGS. 1-3 and 7, to enhance the structural rigidity of the first ladder section 20. The brace 90 generally includes a front panel 92, a back panel 94 and an intermediate panel 96 that extends between the front panel 92 and the back panel 94.

The front panel 92 extends along the first rail leg 42 for attachment thereto. The front panel 92 also is attached to a front edge of the lowermost first rung 26. Similarly, the back panel 94 extends along the first rail web 42 for attachment thereto. The back panel 94 is also attached to a back edge of the lowermost first rung 26. The intermediate panel 96 is attached to the front panel 92 and the back panel 94 proximate the ends of the first rail legs 42 that are opposite the first rail web 40.

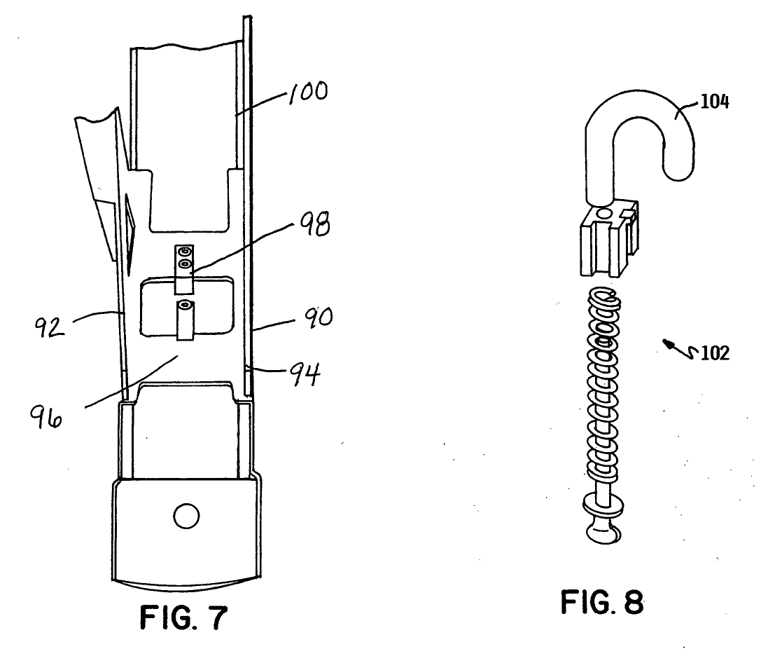

The intermediate panel 96 preferably has a resilient tab 98 attached thereto, as illustrated in FIG. 7. The resilient tab 98 is adapted for engaging an extension 100 for use with the static hinge, which is discussed in more detail below.

The first sections 20 each have a pair of locking mechanisms 102, as illustrated in FIGS. 1-3 and 8. The locking mechanisms 102 are attached to the first side rails 24 proximate an upper end thereof. The locking mechanism 102 preferably includes a lock handle 104. The lock handle 104 is movable between in an engaged position and a disengaged position. The lock handle 104 is preferably biased to the engaged position.

When in the engaged position, the lock handle 104 extends through the first ladder section and engages the second ladder section 22 to maintain the second ladder section 22 in a fixed position with respect to the first ladder section 20. When in the disengaged position, the lock handle 104 permits the second ladder section 22 to slide with respect to the first ladder section 20.

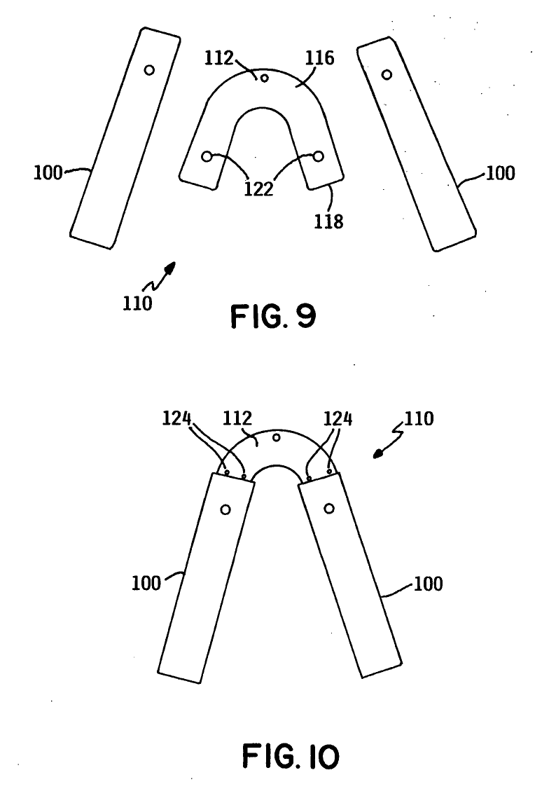

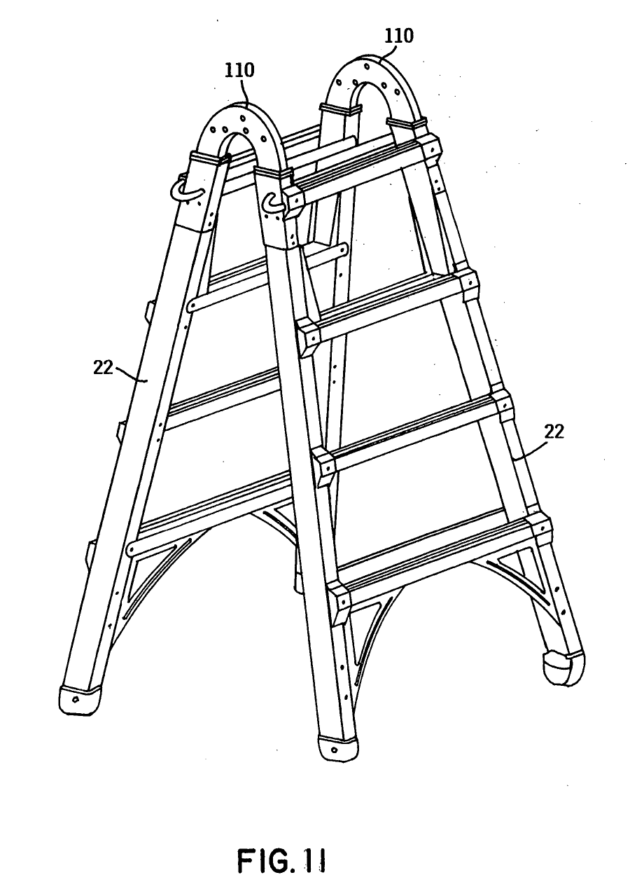

The static hinge mechanism 110 preferably has a three-part configuration with a static hinge plate 112 and two leg extensions 100, as shown most clearly in FIGS. 9-11. Forming the static hinge mechanism 110 in the three-part configuration enables the components of the static hinge mechanism 110 to be stored in a compact configuration. In particular, the leg extensions 100 are stored near the bottom of the first side rails 40, as illustrated in FIG. 7. The two static hinge plates 112 are preferably stored in a storage case (not shown).

The static hinge plate 112 preferably includes three layers: outer layers 116 and an intermediate layer 118. Hence, the intermediate layer 118 is sandwiched between the outer layers 116. The outer and intermediate layers 116, 118 preferably have a generally U-shaped configuration. However, a person of ordinary skill in the art will appreciate that the concepts of the present invention are adaptable for use with the static hinge mechanism 110 having a variety of other shapes.

The static hinge plate 112 further comprises a plurality of apertures 122. The apertures 122 are adapted to receive the locking mechanism 102 for attaching the static hinge mechanism 110 to the first ladder section 20.

The static hinge plate 112 also has at least two knurls 124, such as rivet heads, one on each side of the static hinge plate arc. The knurls 124 on the static hinge plate 112 limit the degree to which the static hinge plate 112 can be inserted into the leg extensions 100.

A thickness of the static hinge mechanism 110 is slightly smaller proximate an end thereof when compared to proximate the knurls 124. The difference in thickness is preferably about 1 millimeter. Using the tapered thickness allows the leg extensions 100 to become snugger with respect to the static hinge mechanism 110 as the extensions 100 are slid onto the static hinge mechanism 110.

A person of ordinary skill in the art will appreciate that it is possible to use an adjustable hinge instead of the static hinge 110 in removably attaching the first ladder sections 20 together to create a convertible ladder that is adaptable for use in at least four different configurations.

Proximate lower ends of the first side rails 40, feet 126 are attached thereto, as illustrated in FIGS. 1-2. The feet 126 enhance the ability of the convertible ladder 10 to remain in a stationary position. The feet 126 are preferably removably attached to the first side rails 24 with a bolt 128. The bolt 128 enables the feet 126 to be readily replaced when damaged.

The second side rails 34 preferably have a rectangularly shaped configuration, as most clearly illustrated in FIG. 1. A person of ordinary skill in the art will appreciate that the size of the second side rails 34 and the second rungs 36 is selected based upon the intended use of the convertible ladder 10.

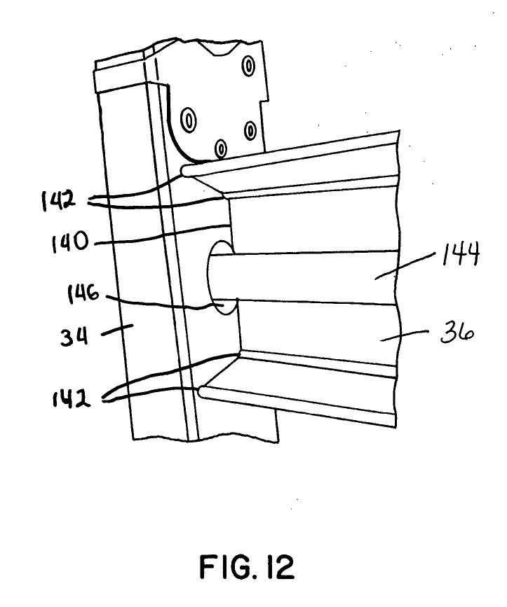

Each rail-facing rung edge 140 of a second rung 36 is configured with four pins 142 protruding from the rail-facing rung edge 140, as most clearly illustrated in FIG. 12. Hence, each second rung 36 contains eight pins 142, four on each rail-facing rung edge 140. The interior face of the second side rail 34, where a second rung 36 is to be affixed, contains four apertures, mirroring the location of the pins on the rail-facing rung edge 140 of a second rung 36. The pins 142 on each rail-facing rung edge 140 are inserted into the apertures in the interior-faces of the second side rails 34.

Further, the second rung 36 also includes a reinforcing bar 144 extending from a back side thereof. An aperture in each interior face of the second side rails 34 is adapted to receive the reinforcing bar 144. A plastic bushing 146 extends through the aperture, spanning the width of the second side rail 34.

The end of the reinforcing bar 144 is inserted into the bushing 146 in the aperture and the reinforcing bar 144 is swaged against the second side rail 34 to thereby retain the second rung 36 in a stationary position with respect to the second side rail 34. The bushing 146 prevents the side walls of the second side rail 34 from collapsing in response to the pressure during the swaging process.

The second side rails 34 and the first side rails 24 are both preferably fabricated from fiberglass. However, a person of ordinary skill in the art will appreciate that the concepts of the present invention may be adapted for use with the first side rails 24, the second side rails 34, the first rungs 26, and the second rungs 36 fabricated from a variety of materials such as steel, aluminum, and wood.

The hinge mechanism 16 includes a handle 150, a first hinge plate 152 and a second hinge plate 154, as most clearly illustrated in FIG. 1. The first hinge plate 152 is pivotally mounted with respect to the second hinge plate 154. The hinge mechanism 16 may also encompass various other configurations that are movable and non-movable.

The hinge mechanism 16 may be permanently attached to the first section 20 and the second section 22. Alternatively, the hinge mechanism 16 may be removably attached to the first section 20 and the second section 22 to facilitate reconfiguring the convertible ladder into other configurations.

It is contemplated that features disclosed in this application, as well as those described in the above applications incorporated by reference, can be mixed and matched to suit particular circumstances. Various other modifications and changes will be apparent to those of ordinary skill.

1. A convertible ladder comprising:
a first ladder section comprising:
a pair of first side rails having an upper end and a lower end;
at least one first rung extending between the pair of first side rails;
a pair of upper rail guides, wherein one of the upper rail guides is attached to each of the first side rails proximate an upper end thereof, wherein the upper rail guide includes an upper channel; and
a pair of intermediate rail guides, wherein one of the intermediate rail guides is attached to each of the first side rails intermediate the upper end and the lower end, wherein the intermediate rail guide includes an intermediate channel; and
a second ladder section comprising:
a pair of second side rails having an upper end and a lower end, wherein the upper channel and the intermediate channel are both adapted to at least partially receive one of the second side rails; and
at least one second rung extending between the pair of second side rails.

2. The convertible ladder of claim 1, wherein the upper rail guide is mounted in a spaced-apart configuration from the intermediate rail guide.

3. The convertible ladder of claim 1, wherein the first side rails are oriented at an angle with respect to each other.

4. The convertible ladder of claim 3, wherein the first side rails are oriented so that the upper ends are closer to each other than the lower ends.

5. The convertible ladder of claim 3, wherein the first side rails are both substantially straight.

6. The convertible ladder of claim 1, wherein the upper rail guide at least partially extends over the upper end of the first side rail.

7. The convertible ladder of claim 1, and further comprising an upper rail reinforcement that at least partially extends over the upper end of the first side rail.

8. The convertible ladder of claim 1, and further comprising a locking mechanism that engages the first ladder section and the second ladder section for maintaining the first ladder section in a stationary position with respect to the second ladder section.

9. The convertible ladder of claim 1, wherein the pair of first side rails and the pair of second side rails are both fabricated from a non-metallic material.

10. A convertible ladder comprising:
a first ladder portion comprising:
a first ladder section comprising:
a pair of first side rails having an upper end and a lower end;
at least one first rung extending between the pair of first side rails;
a pair of upper rail guides, wherein one of the upper rail guides is attached to each of the first side rails proximate an upper end thereof, wherein the upper rail guide includes an upper channel; and
a pair of intermediate rail guides, wherein one of the intermediate rail guides is attached to each of the first side rails intermediate the upper end and the lower end, wherein the intermediate rail guide includes an intermediate channel;
a second ladder section comprising:
a pair of second side rails having an upper end and a lower end, wherein the upper channel and the intermediate channel are both adapted to at least partially receive one of the second side rails; and
at least one second rung extending between the pair of second side rails;
a second ladder portion comprising a third ladder section and a fourth ladder section that are slidably mounted with respect to each other; and
a first hinge mechanism attaching the second ladder section to the fourth ladder section.

11. The convertible ladder of claim 10, and further comprising a second hinge mechanism that is capable of attaching the first ladder section to the third ladder section.

12. The convertible ladder of claim 10, wherein the upper rail guide is mounted in a spaced-apart configuration from the intermediate rail guide.

13. The convertible ladder of claim 10, wherein the first side rails are oriented at an angle with respect to each other.

14. The convertible ladder of claim 13, wherein the first side rails are both substantially straight.

15. The convertible ladder of claim 10, wherein the pair of first side rails and the pair of second side rails are both fabricated from a non-metallic material.

16. A method of using a convertible ladder, the method comprising:
providing a convertible ladder having a first ladder portion and a second ladder portion, wherein the first ladder portion has a pair of first side rails, wherein the second ladder portion has a pair of second side rails, and wherein the first side rails have an upper end and a lower end; and
guiding the second ladder portion as the second ladder portion slides with respect to the first ladder portion with a pair of upper rail guides and a pair of intermediate rail guides, wherein one of the upper rail guides is attached to each of the first side rails proximate an upper end thereof, wherein one of the intermediate rail guides is attached to each of the first side rails intermediate the upper end and the lower end thereof, and wherein the upper rail guides and the intermediate rail guides each have a channel formed therein that is at partially adapted to receive one of the second side rails.

17. The method of claim 16, wherein the first side rails are oriented at an angle with respect to each other.

18. The method of claim 17, wherein the first side rails are both substantially straight.

19. The method of claim 16, and further comprising a maintaining the first ladder section in a stationary position with respect to the second ladder section with a locking mechanism that engages the first ladder section and the second ladder section.

20. The method of claim 16, wherein the pair of first side rails and the pair of second side rails are both fabricated from a non-metallic material.

21. A convertible ladder comprising:
a first ladder section comprising:
a pair of first side rails having an upper end and a lower end; and
at least one first rung extending between the pair of first side rails;
a second ladder section comprising:
a pair of second side rails having an upper end and a lower end; and
at least one second rung extending between the pair of second side rails; and
a connection mechanism comprising:
a main portion having a first end and a second end;
a first extension that is extendable over the first end, and wherein the first extension is extendable into one of the first side rails; and
a second extension that is extendable over the second end and wherein the second extension is extendable into one of the second side rails.

22. The convertible ladder of claim 21, wherein the first end has a first length, wherein the second end has a second length, wherein the first extension has a third length that is longer than the first length, wherein the second extension has a fourth length that is longer than the second length.

23. The convertible ladder of claim 21, wherein at least one of the first side rails and the second side rails has a recess formed therein for receiving at least one of the first extension and the second extension.

24. The convertible ladder of claim 23, and further comprising a resilient tab mounted proximate the recess, wherein the resilient tab is capable of engaging at least one of the first extension and the second extension.

25. The convertible ladder of claim 21, wherein the first end and the second end of the main portion are stationary with respect to each other.

26. The convertible ladder of claim 21, wherein the first end and the second end of the main portion are pivotable with respect to each other.

27. A method of assembling a ladder, the method comprising:
providing a first ladder section comprising a pair of first side rails having an upper end and a lower end and at least one first rung extending between the pair of first side rails;
providing a second ladder section comprising a pair of second side rails having an upper end and a lower end and at least one second rung extending between the pair of second side rails;
extending a first extension over a first end of a main portion;
extending a second extension over a second end of the main portion;
extending the first extension into one of the first side rails; and
extending the second extension into one of the second side rails.

28. The method of claim 22, wherein the first end has a first length, wherein the second end has a second length, wherein the first extension has a third length that is longer than the first length, and wherein the second extension has a fourth length that is longer than the second length.
